(19) United States
(12) Patent Application Publication
(10) Pub. No.: US 2026/0310667 A1
(43) Pub. Date: Oct. 8, 2026

(54) OPEN ANALYTICAL STRUCTURE COMBINING DEPTH AND BREADTH WITH DUAL ENGINES OF THOUGHTS AND METHOD THEREOF

(71) Applicant: Taiwan Intelligence Research and Development CO., LTD., Taipei City (TW)

(72) Inventors: Teng-Ruei Chen, Taipei City (TW); Chen-Che Lu, Taipei City (TW); Hsin Lu, Taipei City (TW)

(21) Appl. No.: 19/257,778

(22) Filed: Jul. 2, 2025

(30) Foreign Application Priority Data
Apr. 2, 2025 (TW) 114112890

(51) Int. Cl. G06F 16/2453

(52) U.S. Cl. CPC G06F 16/24542

(57) ABSTRACT

Provided is an open analytical structure combining depth and breadth with dual engines of thoughts and method thereof. The open analytical structure involves a base prompter, configured to clarify and refine a question input by a user (e.g. a user query); a solver agent module, electrically connected to the base prompter and configured to solve the question and provide an answer; a dual-engine system, electrically connected to the solver agent module and configured to extend a subsequent analysis path and produce more than one analysis result; and a final response agent, electrically connected to the dual-engine system and the solver agent module, and configured to integrate the more than one analysis result and perform final content optimization and structured article output. Therefore, the dual-engine system makes reasoning more comprehensive and focused, and can flexibly structure planning, query, and reasoning.

### CROSS-REFERENCE TO RELATED APPLICATIONS

This application claims the priority of Taiwanese patent application No. 114112890, filed on Apr. 2, 2025, which is incorporated herewith by reference.

### PRIOR ART

Regarding the need for global news analysis, news is an important reflection of social changes and can directly affect financial markets, political decisions, and corporate strategies. In the era of big data, how to deeply analyze valuable insights from news information has become the key.

However, if human experts were to conduct the analysis, it would not only be inefficient but also biased, and it would be difficult to quickly extract the core points from a large amount of real-time information. In addition, some people use traditional large language models (LLM) for analysis. However, traditional large language models are mainly used to solve single tasks and are more difficult to handle open-ended problems. For the technology of using large language models to analyze problems, please refer to the public literature: CoT Wei et al., 2023, CoT-SC Wang et al., 2023, ToT Long, 2023, GoT Besta et al., 2024, etc.

### BACKGROUND OF THE INVENTION

The present invention relates to the technical field of an open analytical framework, in particular to an open analytical structure combining depth and breadth with dual engines of thoughts and method thereof.

### SUMMARY OF THE INVENTION

A primary objective of the present invention is to provide an open analytical structure combining depth and breadth with dual engines of thoughts and method thereof. Through the dual-engine system setting, the engine controller dynamically balances the multi-dimensional exploration of the breadth analysis engine and the in-depth analysis of the depth analysis engine, making the reasoning more comprehensive and focused. Furthermore, through the setting of base prompters and solution agent modules, flexible structured planning, query and reasoning can be achieved, and customized tools can be supported.

In order to achieve the aforementioned objective, the present invention provides an open analytical structure combining depth and breadth with dual engines of thoughts. The open analytical structure combining depth and breadth with dual engines of thoughts includes a base prompter, configured to clarify and refine a question input by a user; a solver agent module, electrically connected to the base prompter and configured to solve the question and provide an answer; a dual-engine system, electrically connected to the solver agent module and configured to extend a subsequent analysis path and produce more than one analysis result; and a final response agent, electrically connected to the dual-engine system and the solver agent module, and configured to integrate the more than one analysis result and perform final content optimization and structured article output.

In a preferred embodiment of the present invention, the solver agent module includes a planner, an executor and a data analysis toolbox, the planner is electrically connected to the base prompter, the executor is electrically connected to the planner and the dual-engine system, and the analysis data toolbox is electrically connected to the planner and the executor.

In a preferred embodiment of the present invention, the planner is configured to perform a task decomposition, an allocation tool, and a plan validation, the executor is configured to perform a task execution, an information integration and a result validation, the data analysis toolbox is configured to include multiple agent tools and support customized requirements.

In a preferred embodiment of the present invention, the dual-engine system includes an engine controller, a breadth analysis engine, and a depth analysis engine, the engine controller is electrically connected to the executor and the final response agent, the breadth analysis engine is electrically connected to the engine controller, and the depth analysis engine is electrically connected to the engine controller.

In a preferred embodiment of the present invention, the engine controller is configured to receive information from the executor that completes the information integration to determine whether to transmit to the breadth analysis engine or the depth analysis engine, the breadth analysis engine is configured to perform a multi-dimensional exploration to ensure that the analysis covers a wide range of possibilities and background knowledge, the depth analysis engine is configured to perform an in-deep reasoning analysis to ensure that the analysis results have a logical rigor and a high resolution.

In order to achieve the aforementioned objective, the present invention provides an open analytical method combining depth and breadth with dual engines of thoughts. The open analytical method combining depth and breadth with dual engines of thoughts includes an input step: inputting a user query; an optimization step: optimizing the user query and converting the user query into a structured analytical question; a solution step: decomposing the structured analytical question and ensuring an integrity and an accuracy of the reasoning through a rigorous verification mechanism to provide a preliminary answer corresponding to the user query; a strategy selection step: determining to perform a breadth analysis step, a depth analysis step or a termination analysis step according to the preliminary answer, thereby outputting a depth analysis question generated by completing the depth analysis step and a breadth analysis question generated by completing the breadth analysis step, and executing the solution step again, performing iterative processing, until a termination condition is met and executing the termination analysis step to output an analysis result; and a final response step: perform final content optimization and structured article output on the analysis results and output a final answer.

In a preferred embodiment of the present invention, the optimization step includes a defuzzification step, a time addition step, an ambiguity clarification step, a name unification step, and an error correction step, the defuzzification step is configured to improve the user query with ambiguity to make it more parsable, the time addition step is configured to ensure that an execution time contains an appropriate time range to improve timeliness, the ambiguity clarification step is configured to standardize the terms and concepts in the user query to avoid misinterpretation, the name unification step is configured to unify the names of terms and concepts to ensure consistency and avoid mismatches due to name differences, the error correction step is configured to check the correctness of the user query and make corrections.

In a preferred embodiment of the present invention, the optimization step further includes an error handling step, analyzing a failure reason of the user query and providing a correction suggestion, while retaining a core intention of the user query to ensure that the user query still meets the user's needs.

In a preferred embodiment of the present invention, the solution step includes a task planning step and a plan validation step; wherein, the task planning step decomposes the user query into 1 to 3 core subtasks through a multi-agent system, matches a suitable analysis tool module and generates an executable input according to an analysis data toolbox, and ensures that a dependency relationship and an execution sequence between the core subtasks form a combined analysis process; the plan validation step includes a completeness check, a redundancy check, and a format check; wherein, the completeness check is configured to ensure that all key information in the user query is covered and the allocation of the core subtasks is correct, the redundancy check is configured to eliminate duplicate or unnecessary inclusion relationships to improve efficiency, the format check is configured to ensure that the core subtasks conform to a standard format to avoid execution errors.

In a preferred embodiment of the present invention, the solution step further includes a task execution step and a result validation step; wherein, the task execution step is based on the dependency relationship between the core subtasks to ensure that each of the corresponding core subtasks is executed only after a prerequisite is met, and the analysis tool module in the analysis data toolbox is used to solve the core subtasks, and all output results are integrated to form a structured summary to provide a basis for subsequent analysis; the result validation step performs a task validation and a summary validation, the task validation is configured to ensure that the output results of each core subtask are consistent with the facts and records the parts to be corrected, the summary validation is configured to ensure that each output result is consistent with the user query without logical contradictions or erroneous information.

### BRIEF DESCRIPTION OF DRAWINGS

Aspects of the present invention are best understood from the following detailed description when read with the accompanying figures. It is noted that, in accordance with the standard practice in the industry, various features are not drawn to scale. In fact, the dimensions of the various features may be increased or reduced for clarity of discussion.

FIG. 1 is a block diagram of an open analytical structure combining depth and breadth with dual engines of thoughts of an embodiment of the present invention.

FIG. 2 is a flow chart of an open analytical method combining depth and breadth with dual engines of thoughts of a first embodiment of the present invention.

FIG. 3 is a thinking tree diagram of the dual-engine system in the open analytical method combining depth and breadth with dual engines of thoughts of the present invention.

FIG. 4 to FIG. 9 are schematic diagrams illustrating of the open analytical method combining depth and breadth with dual engines of thoughts of an embodiment of the present invention.

FIG. 10 is a schematic diagram showing the comparison results between the open analytical method combining depth and breadth with dual engines of thoughts of the present invention and the five major fields and five major standards of GPT-40.

FIG. 11 is a histogram diagram based on the five major fields in FIG. 10.

FIG. 12 is a histogram diagram based on the five major standards in FIG. 10.

FIG. 13 is a schematic diagram showing the comparison results between the open analytical method combining depth and breadth with dual engines of thoughts of the present invention and the five major fields and five major standards of Perplexity AI(llama-3.1-sonar-small-128k-online).

FIG. 14 is a histogram diagram based on the five major fields in FIG. 13.

FIG. 15 is a histogram diagram based on the five major standards in FIG. 13.

### DETAILED DESCRIPTION OF THE INVENTION

It will be appreciated that, although specific embodiments of the present invention are described herein for purposes of illustration, various modifications may be made without departing from the spirit and scope of the present invention.

In the following description, certain specific details are set forth in order to provide a thorough understanding of various aspects of the disclosed subject matter. However, the disclosed subject matter may be practiced without these specific details. In some instances, well-known structures and methods of power delivery comprising embodiments of the subject matter disclosed herein have not been described in detail to avoid obscuring the descriptions of other aspects of the present invention.

Unless the context requires otherwise, throughout the specification and claims that follow, the word “comprise,” “have,” “include,” and variations thereof, such as “comprises,” “comprising,” “having,” “including” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present invention.

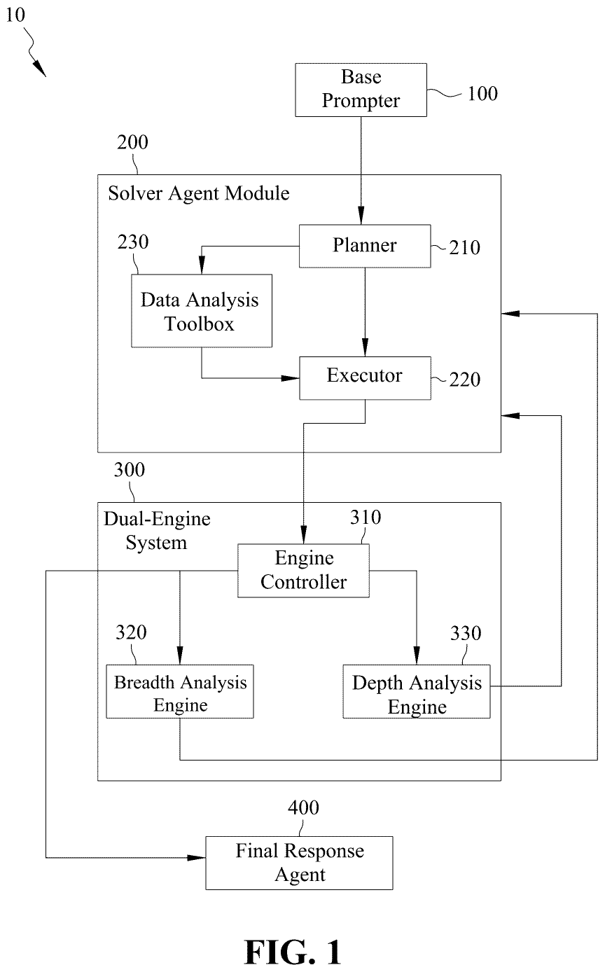

FIG. 1 is a block diagram of an open analytical structure combining depth and breadth with dual engines of thoughts of an embodiment of the present invention.

Please refer to FIG. 1, the open analytical structure 10 combining depth and breadth with dual engines of thoughts of the present invention includes a base prompter 100, a solver agent module 200, a dual-engine system 300, and a final response agent 400. Among them, the dual engines of thoughts are realized by the dual-engine system 300.

The base prompter 100 may be configured to clarify and optimize a question input by a user (i.e., user query). In other words, the base prompter 100 is responsible for optimizing the inputted question (i.e., user query) and converting it into a structured analytical query question to provide accuracy and parsability.

The solver agent module 200 may be electrically connected to the base prompter 100 and configured to solve the question (i.e., user query) and provide an answer. In some embodiments, the solver agent module 200 may include a planner 210, an executor 220, and a data analysis toolbox 230. The planner 210 may be electrically connected to the base prompter 100 and may be configured to perform a task decomposition, an allocation tool, and a plan validation. The executor 220 may be electrically connected to the planner 210 and the dual-engine system 300, and may be configured to perform a task execution, an information integration, and a result validation. The analysis data toolbox 230 may be electrically connected to the planner 210 and the executor 220, and may be configured to include multiple agent tool modules and support customized requirements. In some embodiments, the multiple agent tool modules of the analysis data toolbox 230 may be a news search tool module, an event extraction tool module, a historical analysis tool module, an information searching tool module, and a direct reasoning tool module, respectively. The news search tool module is powered by Perplexity AI (an artificial intelligence search engine from startup Perplexity(llama-3.1-sonar-small-128k-online)), which retrieves and processes the latest news articles, playing a key role in providing real-time information and data. The event extraction tool module analyzes time series and causal relationships through a large language model (LLM), constructs a detailed event timeline, and extracts necessary information about key entities and their roles to facilitate subsequent analysis of behavior. This historical analysis tool module matches current events with historical precedents through a large language model (LLM), identifying key factors that influenced past events, helping to better predict and explain potential future outcomes. The information searching tool module is supported by Perplexity AI to provide real-time data support to fill in the gaps when knowledge gaps are identified, thereby improving the comprehensiveness and accuracy of analysis. The direct reasoning tool module integrates the output of various analysis tools through a large language model (LLM), transforms raw information into valuable insights through logical reasoning and inductive analysis, and provides further exploration directions.

The dual-engine system (DEoT) 300 may be electrically connected to the solver agent module 200 and configured to extend a subsequent analysis path and output a depth analysis result question generated by the depth analysis and a breadth analysis question generated by the breadth analysis, and return them to the solver agent module 200 for iterative processing until one of the termination conditions is met to output an analysis result. In some embodiments, the dual-engine system 300 may include an engine controller 310, a breadth analysis engine 320, and a depth analysis engine 330. The engine controller 310 may be electrically connected to the executor 220 and the final response agent 400, and may be configured to receive information from the executor 220 to complete the information integration to determine whether to transmit to the breadth analysis engine 320 or the depth analysis engine 330; that is, the engine controller 310 is responsible for deciding when to perform a breadth analysis of the breadth analysis engine 320, a depth analysis of the depth analysis engine 320, and a termination analysis, and the large language model (LLM) may be dynamically adjusted according to complexity, progress, answer questions, and resource usage. The breadth analysis engine 320 may be electrically connected to the engine controller 310, and may be configured to perform a multi-dimensional exploration to ensure that the analysis covers a wide range of possibilities and background knowledge; that is, the breadth analysis engine 320 may generate multiple key questions of different aspects (e.g., economics, politics, technology, etc.) to help establish a complete background for the question and generate corresponding analysis queries. The deep analysis engine 330 may be electrically connected to the engine controller 310, and may be configured to perform a deep reasoning analysis to ensure that the analysis result has a logical rigor and a high resolution; that is, the deep analysis engine 330 may generate a follow-up deep analysis question to dig deeper into key issues and provide more detailed insights and conclusions through multi-level reasoning. Through this architecture of the dual-engine system 200, it is possible to achieve both comprehensive exploration and detailed mining to provide efficient and hierarchical analysis results.

The final response agent 400 may be electrically connected to the dual-engine system 300 (i.e., the executor 220) and the solver agent module 200, and is configured to perform final content optimization and structured article output on the analysis result.

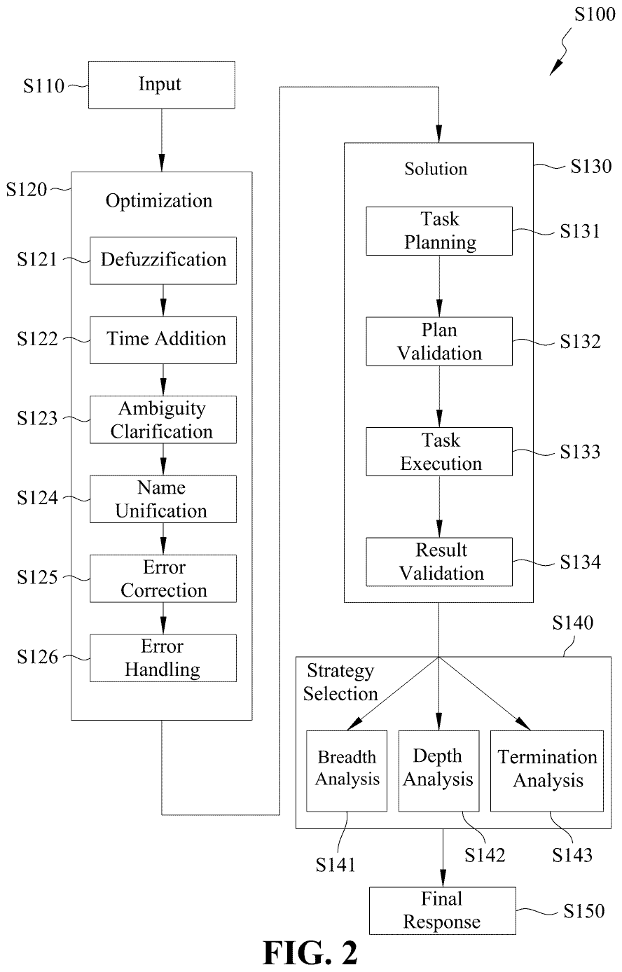

FIG. 2 is a flow chart of an open analytical method combining depth and breadth with dual engines of thoughts of a first embodiment of the present invention.

Please refer to FIG. 2, the open analytical method S100 combining depth and breadth with dual engines of thoughts of the present invention may include steps S110, S120, S130, S140, and S150, which will correspond to the open analytical structure 10 shown in FIG. 1 and will be described in detail later.

Step S110 is an input step. In step S110, a user query is inputted.

Step S120 is an optimization step. In step S120, the user query may be optimized and converted into a structured analysis question through the base prompter 100 shown in FIG. 1. In some embodiments, the optimization step S120 may include a defuzzification step S121, a time addition step S122, an ambiguity clarification step S123, a name unification step S124, and an error correction step S125. The defuzzification step S121 is configured to improve the user query with ambiguity to make it more parseable. The time addition step S122 is configured to ensure that an execution time includes a proper time range to improve timeliness. The ambiguity clarification step S123 is configured to standardize the terms and concepts in the user query to avoid misinterpretation. The name unification step S124 is configured to unify the names of terms and concepts to ensure consistency and avoid mismatching due to name differences. The error correction step S125 is configured to check the correctness of the user query and make corrections.

In some embodiments, the optimization step S120 may further include an error handling step S126. The error handling step S126 is configured to analyze a failure reason of the user query and provide a correction suggestion, while retaining a core intention of the user query to ensure that the user query still meets the user's needs.

Step S130 is a solution step. In step S130, the structured analysis question may be decomposed through the solver agent module 200 shown in FIG. 1 and a rigorous verification mechanism may be configured to ensure the integrity and accuracy of the reasoning to provide a preliminary answer corresponding to the user query. In some embodiments, the solution step S130 may include a task planning step S131 and a plan validation step S132. The task planning step S132 may use the planner 210 shown in FIG. 1 to decompose the user query into 1~3 core subtasks through a multi-agent system (MAS), match a suitable analysis tool module and generate executable input based on an analysis data toolbox, and ensure that a dependency relationship and an execution order between the core subtasks form a combined analysis process. The plan validation step S132 may be completed by the planner 210, which may include a completeness check, a redundancy check, and a format check; wherein, the completeness check is configured to ensure that all key information in the user query is covered and the allocation of the core subtasks is correct; the redundancy check is configured to eliminate duplicate or unnecessary inclusion relationships to improve efficiency; the format check is configured to ensure that the core subtasks conform to a standard format to avoid execution errors. If the plan validation step S132 is failed, plan regeneration is initiated (i.e., returning to step S131 and executing the planner 210 again) to provide specific feedback and correct the user query while retaining the original analysis goal to ensure that the revised plan still meets the expected analysis direction.

In some embodiments, the solution step S130 may further include a task execution step S133 and a result validation step S134. The task execution step S133 is performed by the executor 220 shown in FIG. 1 according to the dependency relationship between the core subtasks to ensure that the corresponding core subtasks are executed only after a prerequisite is met, and the analysis tool module in the analysis data toolbox 230 is used to solve the core subtasks, and all output results are integrated to form a structured summary to provide a basis for subsequent analysis. The result validation step S134 can perform two levels of validation, namely, a task validation and a summary validation. The task validation is configured to ensure that the output results of each core subtask are consistent with the facts and records the parts to be corrected. The summary validation is configured to ensure that each output result is consistent with the user query without logical contradictions or erroneous information. If the result validation step S134 is failed, plan regeneration is initiated (i.e., returning to step S131 and executing the planner 210 again) to provide specific feedback, correct the user query, and retain the original analysis goal.

Step S140 is a strategy selection step. In step S140, the engine controller 310 shown in FIG. 1 determines whether to perform a breadth analysis step S141 of the breadth analysis engine 320 shown in FIG. 1, a depth analysis step S142 of the depth analysis engine 330 shown in FIG. 1, or a termination analysis step S143 according to the preliminary answer, thereby generating a depth analysis question generated by the depth analysis (i.e., the depth analysis step S142) and a breadth analysis question generated by the breadth analysis (i.e., the breadth analysis step S141), and executing the solution step (i.e., step S130) again (for example, returning the depth analysis question and the breadth analysis question to the solver agent module 200), and performing iterative processing until one of the termination conditions is met (i.e., the termination analysis step S143) to generate an analysis result.

Step S150 is a final response step. In step S150, the final response agent 400 shown in FIG. 1 performs final content optimization and structured article output on the analysis result and outputs a final answer.

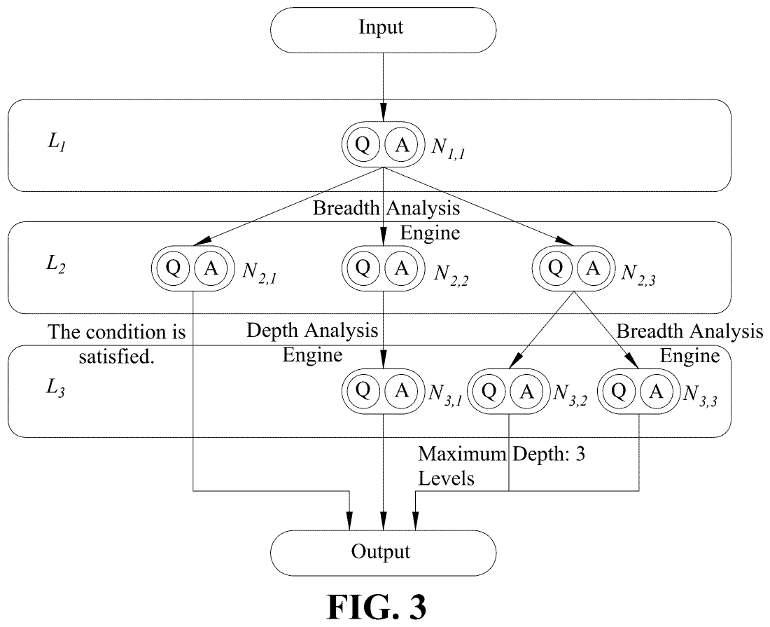

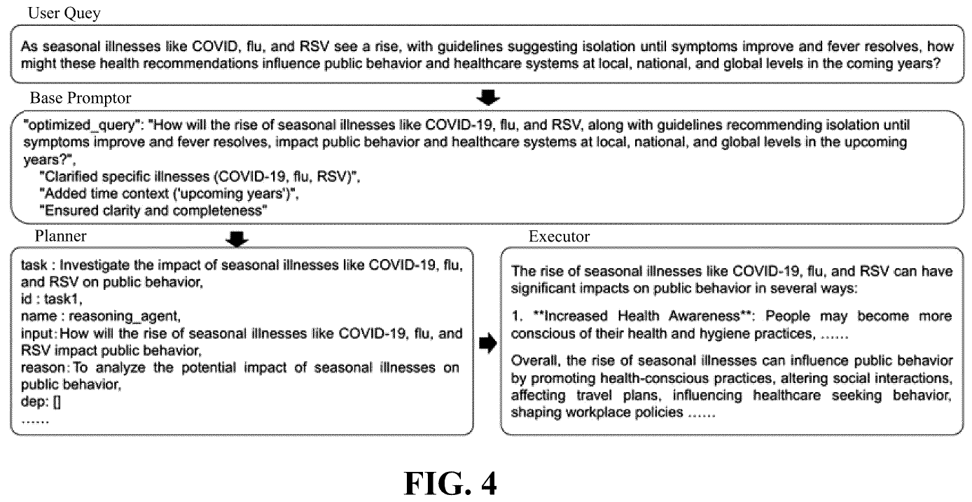

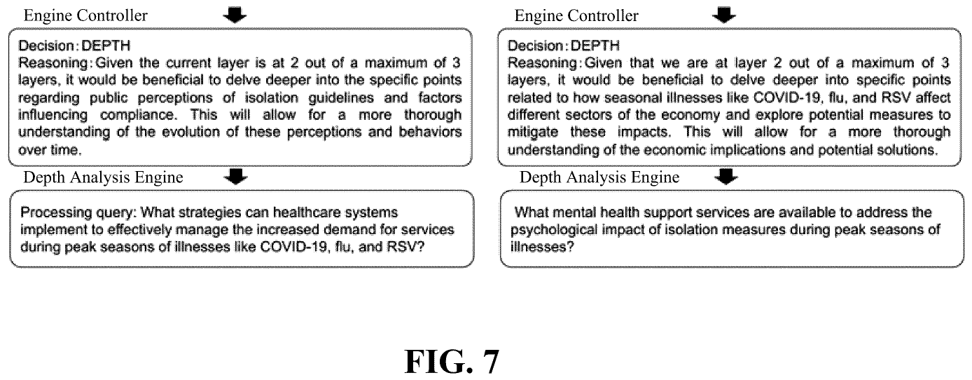

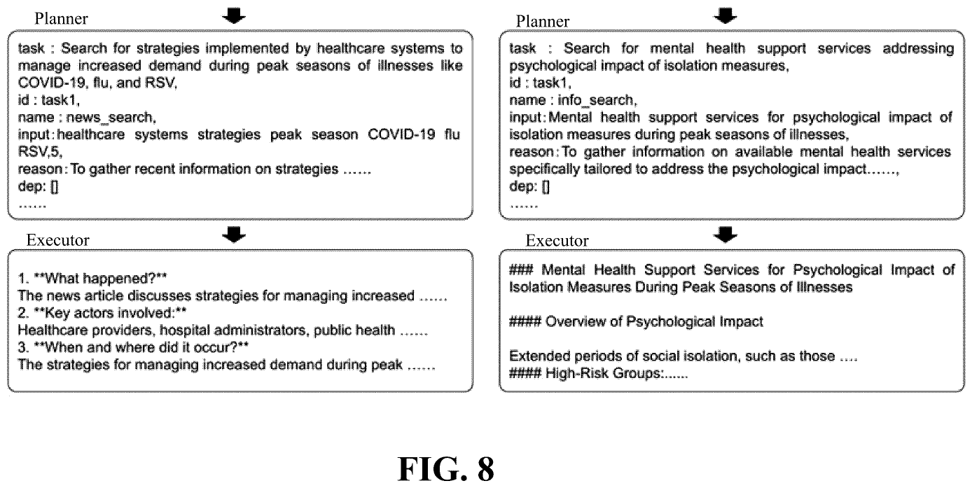

FIG. 3 is a thinking tree diagram of the dual-engine system in the open analytical method combining depth and breadth with dual engines of thoughts of the present invention. FIG. 4 to FIG. 9 are schematic diagrams illustrating of the open analytical method combining depth and breadth with dual engines of thoughts of an embodiment of the present invention.

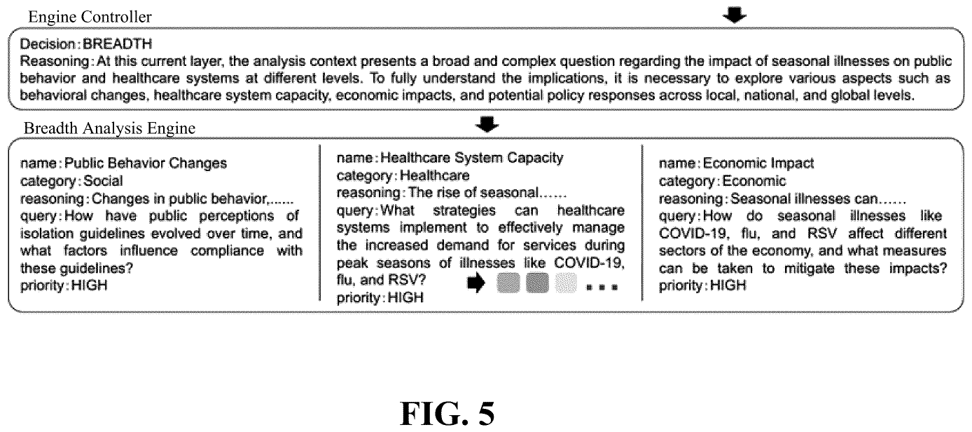

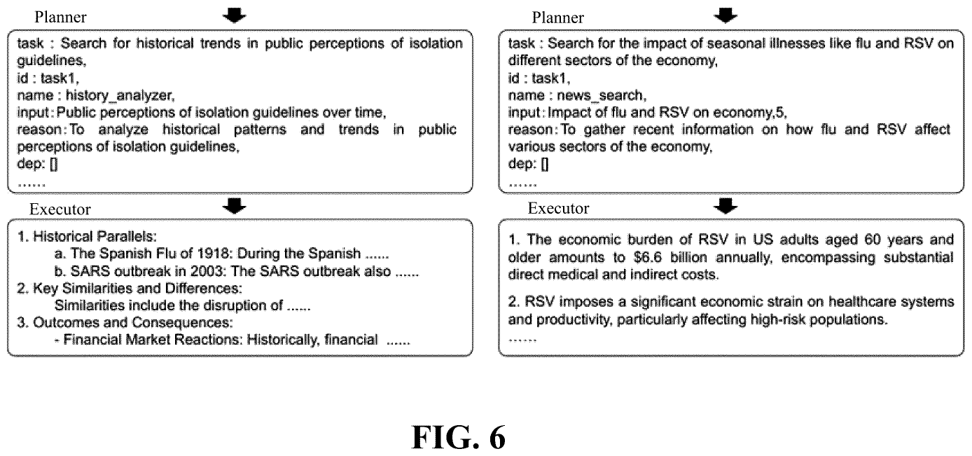

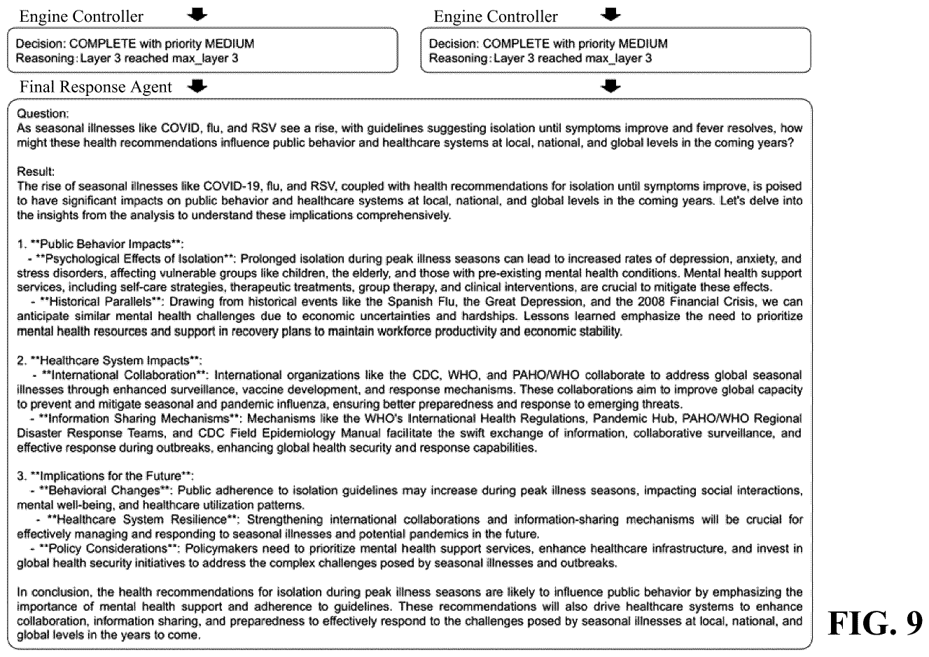

Please refer to FIG. 3, a thought tree diagram of the dual-engine system 300 includes: please refer to FIG. 2, FIG. 3 and FIG. 4, the first level L1 (i.e., initial processing), i.e., receiving the initial answer processed by steps S110, S120, S130 and the base prompter 100 and the solver agent module 200; please refer to FIG. 2, FIG. 3 and FIG. 5, the second level L2 (i.e., engine selection) determines the next analysis direction through the engine controller 310, and the next analysis direction includes a breadth analysis step S141 performed by the breadth analysis engine 320, a depth analysis step S142 performed by the depth analysis engine 330, and a termination analysis step S143 performed directly, thereby generating more than one analysis result; and please refer to FIG. 2, FIG. 3, and FIG. 6 to FIG. 8, i.e., the third level L3 (i.e., iterative processing), the one or more analysis results generated are subjected to the next round of analysis by the solver agent module 200, each pair of [question Q-answer A] is a node N_{i,j}, forming an analysis structure, wherein N represents the number of nodes, i represents the number of levels (i.e., L1, L2, L3), and j represents the number of pairs of [question Q-answer A], the analysis action continues until one of the termination conditions is met, and the termination conditions include: (1) reaching the maximum level of depth, (2) the number of nodes reaches the upper limit, and (3) all analysis objectives are met. Please refer to FIG. 9, which aggregates all node information, generates a complete report, and responds to user query in a structured format (i.e., the Final Response).

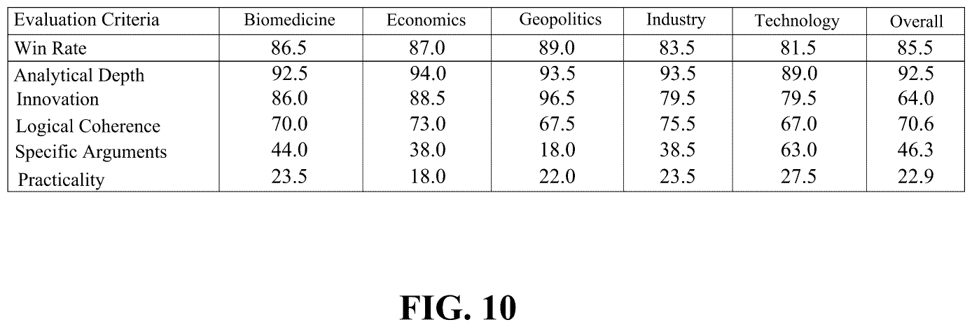

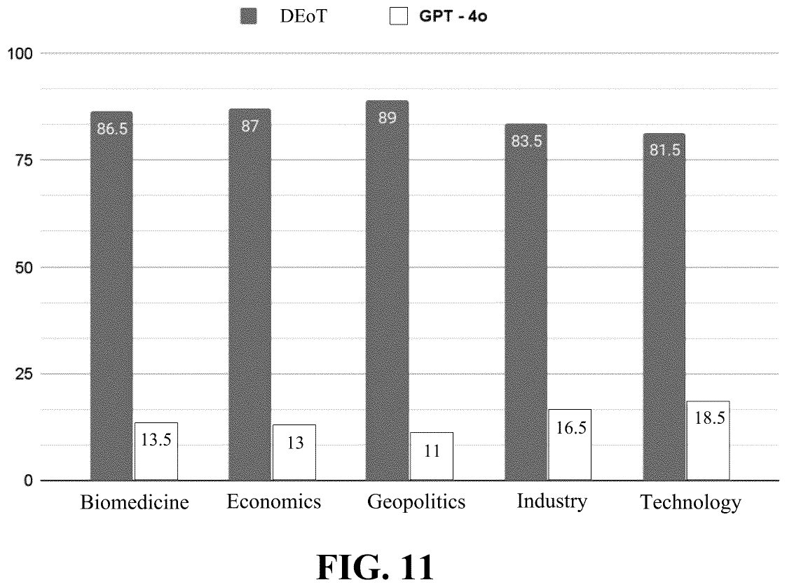

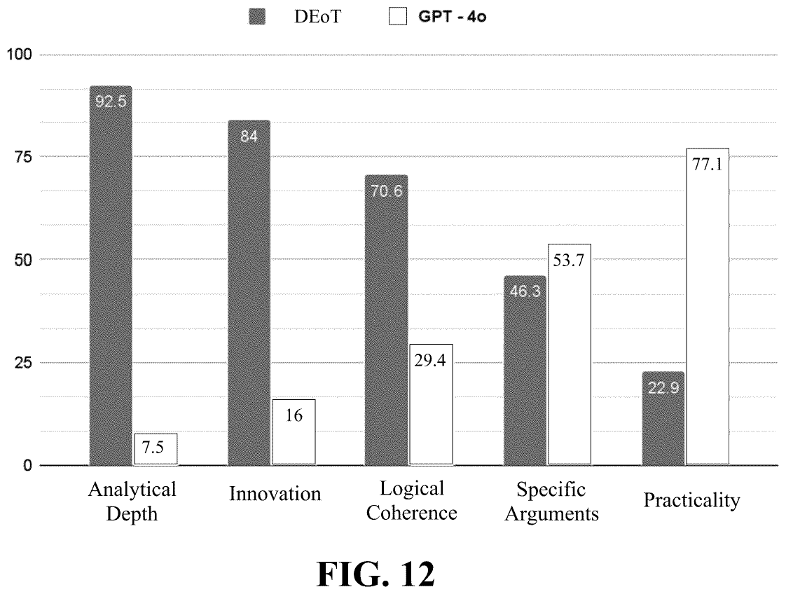

FIG. 10 is a schematic diagram showing the comparison results between the open analytical method combining depth and breadth with dual engines of thoughts of the present invention and the five major fields and five major standards of GPT-40. FIG. 11 is a histogram diagram based on the five major fields in FIG. 10. FIG. 12 is a histogram diagram based on the five major standards in FIG. 10. Wherein, GPT-40 is an advanced general LLM, known for its powerful natural language processing and logical reasoning capabilities.

In FIG. 10, the horizontal content selects five core areas to test reasoning ability in different scenarios, while the vertical content selects five evaluation criteria for evaluation. The five core areas include Biomedicine (including medical research, pharmaceuticals, biotechnology, health innovation, etc.), Economics (including finance, markets, trade, business, economic news), Geopolitics (including international relations, political events, conflicts, the impact of policies on the market, etc.), Industry (including manufacturing, energy, transportation, construction and other industrial fields), Technology (including technological progress, IT industry, hardware and software, artificial intelligence, etc.). 100 questions are selected in each field, for a total of 500 open-ended questions, to provide complete comparative data for the analytical performance of the open analytical structure 10 and the open analytical method S100 of the present invention. The five evaluation criteria include Analytical Depth (including measuring the model's in-depth understanding of the logical relationship, influencing factors and key issues of the user query), Specific Arguments (including evaluating whether the model may effectively retrieve and use relevant data, cases or historical analogies to support its arguments), Innovation (including measuring whether the model may provide unique insights and innovative solutions in real-world application scenarios and demonstrate creativity), Practicality (including testing whether the conclusions are feasible and considering the operability of real-world applications rather than just theoretical value), and Logical Coherence (including testing the structural integrity and internal consistency of the model's reasoning process to ensure the logical clarity of the argument). At the same time, in order to avoid the issue of order bias, the evaluation method adopts a dual comparison test. Each group of responses undergoes two rounds of independent comparisons with the input order exchanged, and each round of comparison is scored independently, including five major evaluation criteria and overall content, and six binary win-loss judgments are made. Finally, the win rate is calculated.

Please refer to FIGS. 10 and 11, the open analytical structure 10 and the open analytical method S100 combining depth and breadth with dual engines of thoughts of the present invention have a total win rate of 85.5% in all test fields, and the individual scores of each field are all over 81.5%. It performed outstandingly in the field of Geopolitics, with an 89% win rate, demonstrating its advantages in international relations analysis, policy evaluation and multi-level reasoning. The above evaluation results indicate that the open analytical structure 10 combining depth and breadth with dual engines of thoughts of the present invention and the open analytical method S100 may effectively integrate information and clarify cause-effect relationships, providing more in-depth analysis and reasoning results. Please refer to FIG. 10 and FIG. 12 again. The open analytical structure 10 and the open analytical method S100 of the present invention perform excellently in terms of analytical depth, with a win rate of 92.5%, demonstrating its powerful multi-level reasoning ability. It outperforms GPT-40 in terms of logical coherence 92.5% and innovation 70.6%, showing its competitive advantage in structured reasoning for complex problems. In terms of practicality, the win rate was lower at 22.9%, which may be due to the higher depth of reasoning and the more academic or theoretical answers, rather than directly providing decision-making solutions in a short period of time.

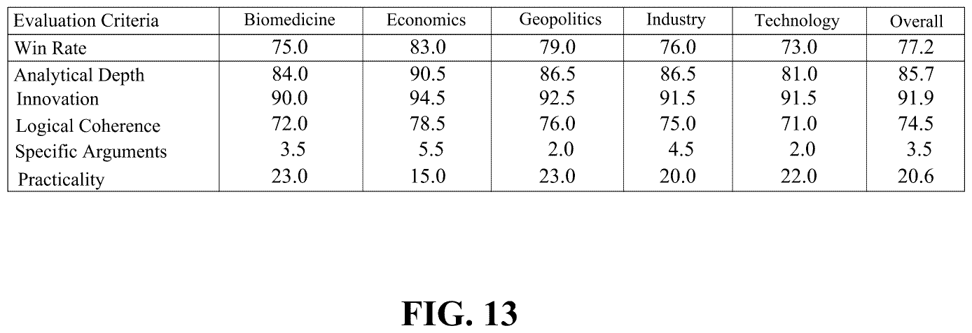

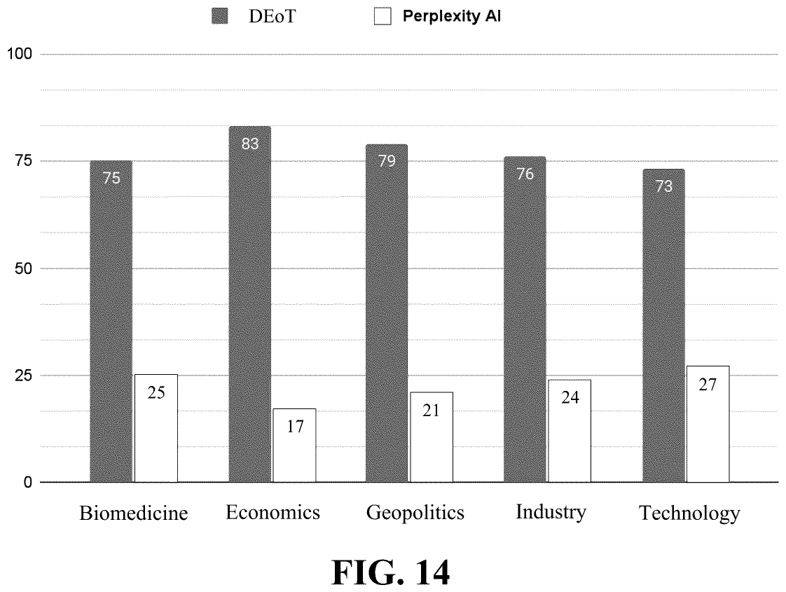

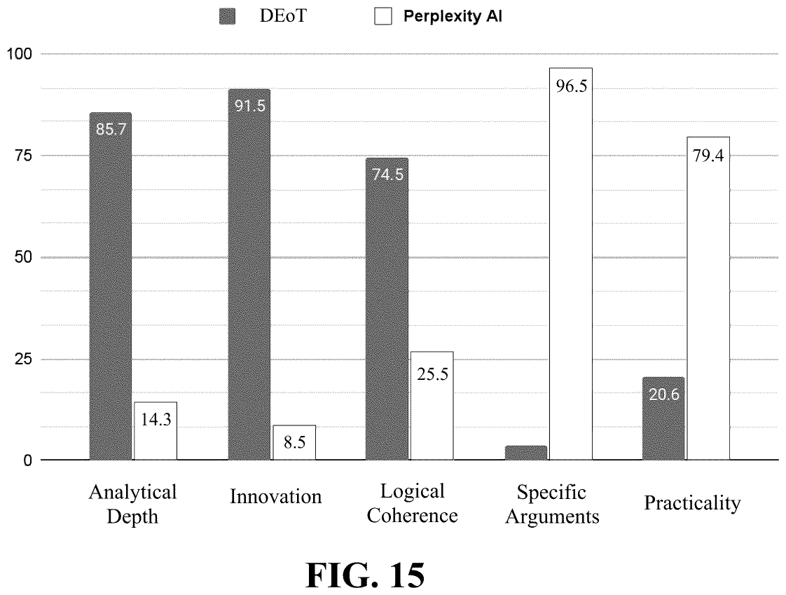

FIG. 13 is a schematic diagram showing the comparison results between the open analytical method combining depth and breadth with dual engines of thoughts of the present invention and the five major fields and five major standards of Perplexity AI(llama-3.1-sonar-small-128k-online). FIG. 14 is a histogram diagram based on the five major fields in FIG. 13. FIG. 15 is a histogram diagram based on the five major standards in FIG. 13. Wherein, Perplexity AI (llama-3.1-sonar-small-128k-online) is an LLM combined with real-time retrieval, specializing in information integration and rapid response generation.

In FIG. 13, the horizontal content selects five core areas to test reasoning ability in different scenarios, while the vertical content selects five evaluation criteria for evaluation. The five core areas include Biomedicine (including medical research, pharmaceuticals, biotechnology, health innovation, etc.), Economics (including finance, markets, trade, business, economic news), Geopolitics (including international relations, political events, conflicts, the impact of policies on the market, etc.), Industry (including manufacturing, energy, transportation, construction and other industrial fields), Technology (including technological progress, IT industry, hardware and software, artificial intelligence, etc.). 100 questions are selected in each field, for a total of 500 open-ended questions, to provide complete comparative data for the analytical performance of the open analytical structure 10 and the open analytical method S100 of the present invention. The five evaluation criteria include Analytical Depth (including measuring the model's in-depth understanding of the logical relationship, influencing factors and key issues of the user query), Specific Arguments (including evaluating whether the model may effectively retrieve and use relevant data, cases or historical analogies to support its arguments), Innovation (including measuring whether the model may provide unique insights and innovative solutions in real-world application scenarios and demonstrate creativity), Practicality (including testing whether the conclusions are feasible and considering the operability of real-world applications rather than just theoretical value), and Logical Coherence (including testing the structural integrity and internal consistency of the model's reasoning process to ensure the logical clarity of the argument). At the same time, in order to avoid the issue of order bias, the evaluation method adopts a dual comparison test. Each group of responses undergoes two rounds of independent comparisons with the input order exchanged, and each round of comparison is scored independently, including five major evaluation criteria and overall content, and six binary win-loss judgments are made. Finally, the win rate is calculated.

Please refer to FIGS. 13 and 14, the total win rate of the open analytical structure 10 combining depth and breadth with dual engines of thoughts of the present invention and the open analytical method S100 is 77.2%, which is slightly lower than the win rate against GPT-40. This may be attributed to the fact that Perplexity AI (llama-3.1-sonar-small-128k-online) has instant retrieval capabilities and has certain advantages in N2Q (News-to-Question Dataset, a set of open questions automatically generated based on the latest news content). In the field of Economics, it has an excellent win rate of 83.0%, which shows that it is superior to Perplexity AI (llama-3.1-sonar-small-128k-online) in market dynamics analysis, policy impact assessment and economic modeling. The above evaluation results indicate that the open analytical structure 10 and the open analytical method S100 of the present invention may more effectively analyze the fluctuating economic environment and provide structured explanations and inferences. Please refer to FIGS. 13 and 15, the open analytical structure 10 combining depth and breadth with dual engines of thoughts of the present invention and the open analytical method S100 have outstanding performance in innovation (Innovation) with a win rate of 91.9%, mainly benefiting from its dual-engine architecture to promote more creative and diverse reasoning. It surpassed Perplexity AI (llama-3.1-sonar-small-128k-online) in terms of Analytical Depth 85.7% and Logical Coherence 74.5%, further demonstrating its advantages in multi-level reasoning ability and structured thinking. The poor performance in Specific Arguments 3.5% may be due to the fact that Perplexity AI relies on instant retrieval and has an advantage in argument support and richness of details.

In summary, the open analytical structure 10 combining depth and breadth with dual engines of thoughts of the present invention and the open analytical method S100, through the setting of the dual-engine system, dynamically balances the multi-dimensional exploration of the breadth analysis engine and the depth analysis of the depth analysis engine through the engine controller, making the reasoning more comprehensive and focused. Furthermore, through the setting of base prompters and solver agent modules, it is possible to flexibly structure plans, queries and reasoning, and support customized tools.

The above descriptions are only used to explain the preferred embodiments of the present invention, and are not intended to limit the present invention in any form. Therefore, any modifications or changes made to the present invention under the same inventive spirit should still be included in the scope of protection intended by the present invention.

1. An open analytical structure combining depth and breadth with dual engines of thoughts, comprising:
a base prompter, configured to clarify and refine a question input by a user;
a solver agent module, electrically connected to the base prompter and configured to solve the question and provide an answer;
a dual-engine system, electrically connected to the solver agent module and configured to extend a subsequent analysis path and produce more than one analysis result; and
a final response agent, electrically connected to the dual-engine system and the solver agent module, and configured to integrate the more than one analysis result and perform final content optimization and structured article output.

2. The open analytical structure according to claim 1, wherein the solver agent module includes a planner, an executor and a data analysis toolbox, the planner is electrically connected to the base prompter, the executor is electrically connected to the planner and the dual-engine system, and the analysis data toolbox is electrically connected to the planner and the executor.

3. The open analytical structure according to claim 2, wherein the planner is configured to perform a task decomposition, an allocation tool, and a plan validation, the executor is configured to perform a task execution, an information integration and a result validation, the data analysis toolbox is configured to include multiple agent tools and support customized requirements.

4. The open analytical structure according to claim 3, wherein the dual-engine system includes an engine controller, a breadth analysis engine, and a depth analysis engine, the engine controller is electrically connected to the executor and the final response agent, the breadth analysis engine is electrically connected to the engine controller, and the depth analysis engine is electrically connected to the engine controller.

5. The open analytical structure according to claim 4, wherein the engine controller is configured to receive information from the executor that completes the information integration to determine whether to transmit to the breadth analysis engine or the depth analysis engine, the breadth analysis engine is configured to perform a multi-dimensional exploration to ensure that the analysis covers a wide range of possibilities and background knowledge, the depth analysis engine is configured to perform an in-deep reasoning analysis to ensure that the analysis results have a logical rigor and a high resolution.

6. An open analytical method combining depth and breadth with dual engines of thoughts, comprising:
an input step: inputting a user query;
an optimization step: optimizing the user query and converting the user query into a structured analytical question;
a solution step: decomposing the structured analytical question and ensuring an integrity and an accuracy of the reasoning through a rigorous verification mechanism to provide a preliminary answer corresponding to the user query;
a strategy selection step: determining to perform a breadth analysis step, a depth analysis step or a termination analysis step according to the preliminary answer, thereby outputting a depth analysis question generated by completing the depth analysis step and a breadth analysis question generated by completing the breadth analysis step, and executing the solution step again, performing iterative processing, until a termination condition is met and executing the termination analysis step to output an analysis result; and
a final response step: perform final content optimization and structured article output on the analysis results and output a final answer.

7. The open analytical method according to claim 6, wherein the optimization step includes a defuzzification step, a time addition step, an ambiguity clarification step, a name unification step, and an error correction step, the defuzzification step is configured to improve the user query with ambiguity to make it more parsable, the time addition step is configured to ensure that an execution time contains an appropriate time range to improve timeliness, the ambiguity clarification step is configured to standardize the terms and concepts in the user query to avoid misinterpretation, the name unification step is configured to unify the names of terms and concepts to ensure consistency and avoid mismatches due to name differences, the error correction step is configured to check the correctness of the user query and make corrections.

8. The open analytical method according to claim 7, wherein the optimization step further includes an error handling step, analyzing a failure reason of the user query and providing a correction suggestion, while retaining a core intention of the user query to ensure that the user query still meets the user's needs.

9. The open analytical method according to claim 8, wherein the solution step includes a task planning step and a plan validation step; wherein, the task planning step decomposes the user query into 1 to 3 core subtasks through a multi-agent system, matches a suitable analysis tool module and generates an executable input according to an analysis data toolbox, and ensures that a dependency relationship and an execution sequence between the core subtasks form a combined analysis process; the plan validation step includes a completeness check, a redundancy check, and a format check; wherein, the completeness check is configured to ensure that all key information in the user query is covered and the allocation of the core subtasks is correct, the redundancy check is configured to eliminate duplicate or unnecessary inclusion relationships to improve efficiency, the format check is configured to ensure that the core subtasks conform to a standard format to avoid execution errors.

10. The open analytical method according to claim 9, wherein the solution step further includes a task execution step and a result validation step; wherein, the task execution step is based on the dependency relationship between the core subtasks to ensure that each of the corresponding core subtasks is executed only after a prerequisite is met, and the analysis tool module in the analysis data toolbox is used to solve the core subtasks, and all output results are integrated to form a structured summary to provide a basis for subsequent analysis; the result validation step performs a task validation and a summary validation, the task validation is configured to ensure that the output results of each core subtask are consistent with the facts and records the parts to be corrected, the summary validation is configured to ensure that each output result is consistent with the user query without logical contradictions or erroneous information.
